(19) United States
(12) Patent Application Publication
(10) Pub. No.: US 2014/0210758 A1
(43) Pub. Date: Jul. 31, 2014

(54) MOBILE TERMINAL FOR GENERATING HAPTIC PATTERN AND METHOD THEREFOR

(71) Applicant: Samsung Electronics Co., Ltd., Gyeonggi-do (KR)

(72) Inventors: Jin-Hyoung PARK, Gyeonggi-do (KR); Yu-Na KIM, Gyeonggi-do (KR); Ju-Youn LEE, Gyeonggi-do (KR)

(73) Assignee: Samsung Electronics Co., Ltd., Gyeonggi-do (KR)

(21) Appl. No.: 14/168,539

(22) Filed: Jan. 30, 2014

(30) Foreign Application Priority Data
Jan. 30, 2013 (KR) 10-2013-0010624

(51) Int. Cl. G06F 3/01; G06F 3/0488; G06F 3/0482

(52) U.S. Cl. CPC G06F 3/016; G06F 3/0482; G06F 3/0488
USPC 345/173

(57) ABSTRACT

Provided are a portable terminal that generates a haptic pattern and a method thereof. The method includes displaying a menu on a touch screen, receiving an input for generating a haptic pattern through the displayed menu, detecting, using a sensor module, a haptic input provided through the portable terminal, and generating the haptic pattern based on the provided haptic input.

### PRIORITY

This application claims priority under 35 U.S.C. §119(a) to Korean Application Serial No. 10-2013-0010624, as filed in the Korean Intellectual Property Office on Jan. 30, 2013, the contents of which are incorporated herein by reference.

### BACKGROUND OF THE INVENTION

1. Field of the Invention

The present invention relates generally to a portable terminal, and more particularly, to a portable terminal that generates a haptic pattern and a method thereof.

2. Description of the Related Art

A range of new services and supplementary features have recently been provided in portable terminals. Various applications executable in a portable terminal have been developed to increase an effective value of a portable terminal and to satisfy various desires of users.

Therefore, a portable terminal that is mobile and includes a touch screen, such as a smart phone, a portable phone, a notebook Personal Computer (PC), and a tablet PC, stores as many as hundreds of applications. Objects (or shortcut icons) for executing respective applications are displayed on a touch screen of the portable terminal. Accordingly, a user touches one of the shortcut icons displayed on the touch screen so as to execute a desired application in the portable terminal. In addition to the shortcut icons, visual objects provided in various forms such as a widget, a picture, and a document are displayed on the touch screen of the portable terminal.

In this manner, the portable terminal provides a touch input scheme that touches the displayed objects using an input unit such as a finger of a user, an electronic pen, and a stylus pen.

In this instance, the touch input scheme includes a touch input scheme based on a touch by a body part of a user or an input unit that is capable of touching and a non-touch based input scheme such as a hovering, which provides a convenient user interface.

When a touch input exists, an input scheme using a touch screen employs generating a vibration through a vibration device so that a user can experience a sensation as if the user presses a button. Studies on various touch input technologies have been continuously conducted, and studies for satisfying demand for an enjoyable and new multi-sensation interface which users desire have been actively conducted.

However, the conventional haptic pattern is set in advance by a manufacturer of the portable terminal. When the user produces a haptic pattern, the user merely selects at least one haptic pattern from a haptic pattern list associated with set events.

Therefore, there is a need in the art for a new method that enables users to readily produce a haptic effect, for providing a haptic pattern.

### SUMMARY OF THE INVENTION

Aspects of the present invention are to address at least the above-mentioned problems and/or disadvantages and to provide at least the advantages described below. Accordingly, an aspect of the present invention is to provide a portable terminal that includes at least one touch screen and generates a haptic pattern, which enables a user to readily generate and provide a haptic pattern using the portable terminal, and a method thereof.

In accordance with an aspect of the present invention, a method of generating a haptic pattern in a portable terminal includes displaying a menu on a touch screen, receiving an input for generating a haptic pattern through the displayed menu, detecting, using a sensor module, a haptic input through the portable terminal, and generating the haptic pattern based on the input haptic pattern.

In accordance with an aspect of the present invention, a portable terminal that generates a haptic pattern includes a touch screen that displays a menu for generating a haptic pattern, a sensor module, and a controller that controls generation of a haptic pattern based on an input for generating a haptic pattern, which is input through the displayed menu, and at least one haptic input from among tapping on the portable terminal and shaking the portable terminal, which is input through the portable terminal and is detected by the sensor module.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a portable terminal that provides a haptic effect according to an embodiment of the present invention;

FIG. 2 is a front perspective view of a portable terminal according to an embodiment of the present invention;

FIG. 3 is a back perspective view of a portable terminal according to an embodiment of the present invention;

FIG. 4 illustrates an input unit and a view of a touch screen according to an embodiment of the present invention;

FIG. 5 is a block diagram illustrating an input unit that provides a haptic effect according to an embodiment of the present invention;

FIG. 6 illustrates a method of setting a haptic pattern according to an embodiment of the present invention;

FIG. 7 illustrates an example of setting a haptic pattern according to an embodiment of the present invention;

FIG. 8 illustrates a process of generating a haptic pattern by tapping on a portable terminal according to an embodiment of the present invention;

FIG. 9A illustrates an example of tapping on a portable terminal according to an embodiment of the present invention;

FIG. 9B illustrates an example of a change in an intensity of tapping when tapping on a portable terminal according to an embodiment of the present invention;

FIG. 9C is a graph illustrating a voltage associated with an intensity of tapping that exceeds a threshold value when tapping on a portable terminal according to an embodiment of the present invention;

FIG. 9D illustrates an example of a result of editing a haptic waveform generated by tapping on a portable terminal according to an embodiment of the present invention;

FIG. 10A illustrates a waveform of a haptic pattern generated by tapping on a portable terminal;

FIG. 10B illustrates a waveform after editing the haptic pattern generated in FIG. 10A;

FIG. 11 illustrates a process of generating a haptic pattern by shaking a portable terminal according to an embodiment of the present invention;

FIG. 12A illustrates an example of shaking a portable terminal according to an embodiment of the present invention;

FIG. 12B illustrates an example of a change in a speed of shaking when shaking a portable terminal according to an embodiment of the present invention;

FIG. 12C is a graph illustrating a voltage associated with a speed of shaking that exceeds a threshold value when shaking a portable terminal according to an embodiment of the present invention;

FIG. 12D illustrates an example of a result of editing a haptic waveform generated by shaking a portable terminal according to an embodiment of the present invention;

FIG. 13A illustrates a waveform before editing a haptic pattern generated by shaking a portable terminal according to an embodiment of the present invention;

FIG. 13B illustrates a waveform after editing a haptic pattern generated by shaking a portable terminal according to an embodiment of the present invention; and

FIG. 14 illustrates a process of executing a previously designated function based on a pattern input to a portable terminal according to an embodiment of the present invention.

### DETAILED DESCRIPTION OF EMBODIMENTS OF THE INVENTION

The following description with reference to the accompanying drawings is provided to assist in a comprehensive understanding of embodiments of the invention as defined by the claims and their equivalents. Those of ordinary skill in the art will recognize that various changes and modifications of the embodiments described herein can be made without departing from the scope and spirit of the invention. In addition, descriptions of well-known functions and constructions are omitted for the sake of clarity and conciseness.

While terms including ordinal numbers, such as “first” and “second,” etc., is used to describe various components, such components are not limited by the above terms. The terms are used merely to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application are for the purpose of describing particular embodiments, and are not intended to be limiting of the invention. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the same meanings as the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Terms used in the present invention are defined as follows.

A portable terminal: a device that is portable and is capable of transceiving data and performing voice and video calls, and includes at least one touch screen.

An input unit: including at least one of a finger, an electronic pen, and a stylus pen that provides a portable terminal with a command or an input when touching a touch screen or a non-touch such as a hovering.

An object: that which is displayed or to be displayed on a touch screen of a portable terminal, and includes at least one of a document, a widget, a picture, a moving picture, an e-mail, an SMS message, and an MMS message, and is executed, removed, cancelled, stored, and changed by an input unit. The object may also be used as an inclusive concept including a shortcut icon, a thumbnail image, and a folder that stores at least one object in a portable terminal.

A shortcut icon: that which is displayed on a touch screen of a portable terminal for quick execution of each application or a function basically provided in the portable terminal, such as a call, contacts, and a menu, and when a command or an input for executing an application is input, the corresponding application is executed.

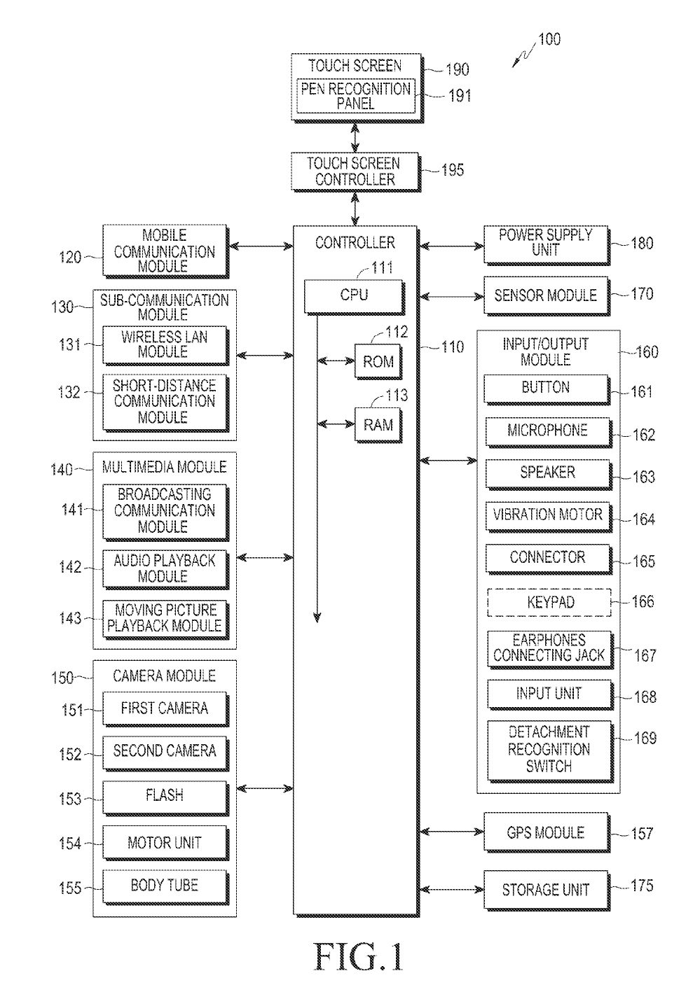

FIG. 1 is a block diagram illustrating a portable terminal that provides a haptic effect according to an embodiment of the present invention.

Referring to FIG. 1, a portable terminal 100 is connected to an external device (not illustrated) using at least one of a mobile communication module 120, a sub-communication module 130, a connector 165, and an earphones connecting jack 167. The external device includes various devices that are detachable from the portable terminal 100 and are wire connected to the portable terminal 100, such as earphones, an external speaker, a Universal Serial Bus (USB) memory, a charging device, a cradle/dock, a Digital Multimedia Broadcasting (DMB) antenna, a mobile payment device, a health care device such as a glucometer, a game console, and a navigation device for a vehicle. The external device includes a Bluetooth® communication device, a Near Field Communication (NFC) device, and a WiFi Direct communication device, and a radio Access Point (AP) which are wirelessly connected. The portable terminal is wire or wirelessly connected to another device, that is, a portable terminal, a smart phone, a tablet Personal Computer (PC), a desktop PC, and a server.

Referring to FIG. 1, the portable terminal 100 includes at least one touch screen 190 and at least one touch screen controller 195. The portable terminal 100 includes the controller 110, the mobile communication module 120, the sub-communication module 130, a multimedia module 140, a camera module 150, a Global Positioning System (GPS) module 157, an input/output module 160, a sensor module 170, a storage unit 175, and a power supply unit 180.

The sub-communication module 130 includes at least one of a wireless Local Area Network (LAN) module 131 and a short-distance communication module 132, and the multimedia module 140 includes at least one of a broadcasting communication module 141, an audio playback module 142, and a moving picture playback module 143. The camera module 150 includes at least one of a first camera 151 and a second camera 152. The camera module 150 of the portable terminal 100 includes at least one of a body tube 155 for zooming in/out of the first camera 151 and/or the second camera 152, a motor unit 154 to control a movement of the body tube 155 for zooming in/out, and a flash 153 that provides a light source for capturing, based on a main purpose of the portable terminal 100. The input/output module 160 includes at least one of a button 161, a microphone 162, a speaker 163, a vibration motor 164, the connector 165, and a key pad 166.

The controller 110 includes a Central Processing Unit (CPU) 111, a Read-Only Memory (ROM) 112 that stores a control program for controlling the portable terminal 100, and a Random Access Memory (RAM) 113 that stores a signal or data input from the outside of the portable terminal 100 or is used as a memory region for an operation 5 performed in the portable terminal 100. The CPU 111 includes a single-core, a dual-core, a triple-core, or a quad-core. The CPU 111, the ROM 112, and the RAM 113 are mutually connected through an internal bus.

The controller 110 controls the mobile communication module 120, the sub-communication module 130, the multimedia module 140, the camera module 150, the GPS module 157, the input/output module 160, the sensor module 170, the storage unit 175, the power supply unit 180, the touch screen 190, and the touch screen controller 195.

The controller 110 determines whether a hovering is recognized as the input unit 168 that is capable of inputting a touch, such as an electronic pen, approaches one of objects or determines whether a touch by the input unit 168 exists on the touch screen 190, when a plurality of objects are displayed on the touch screen 190. The controller 110 senses a height from the portable terminal 100 to the input unit 168, and senses a hovering input associated with the height. That is, the controller 110 senses a hovering input by the input unit 168 on the touch screen 190, or a touch input occurring from a touch by the input unit 168 on the touch screen 190.

The controller 110 controls generation of a haptic pattern, based on at least one condition required for applying a haptic pattern input through a displayed haptic pattern setting menu, and a haptic input of the portable terminal 100. The generated haptic pattern is edited to suit the user's taste. A haptic input of the portable terminal 100 includes at least one of tapping on a portable terminal and shaking a portable terminal. That is, the controller 110 recognizes tapping on a portable terminal or shaking a portable terminal through the sensor module 170 included in the portable terminal 100. The at least one condition includes a shaking setting associated with shaking a portable terminal, a tapping setting associated with tapping a portable terminal, a threshold value setting for sensing an input pattern, and a musical instrument setting associated with a musical instrument to be applied to a haptic pattern.

The controller 110 applies the generated haptic pattern to at least one function provided in the portable terminal. When the at least one function is executed, a vibration of the portable terminal is controlled through a haptic feedback (that is, vibration) corresponding to the generated haptic pattern. When at least one haptic input from among shaking the portable terminal and tapping on the portable terminal is sensed, the controller 110 compares the sensed haptic input and a haptic pattern that is stored in advance. When the comparison result reveals that they are identical, at least one function applied to the haptic pattern stored in advance is executed.

The mobile communication module 120 connects the portable terminal 100 to an external device through mobile communication, using at least one antenna or a plurality of antennas (not illustrated) based on a control of the controller 110. The mobile communication module 120 performs transmitting and receiving of a wireless signal for a voice call, a video call, a Short Message Service (SMS), or a Multimedia Message Service (MMS), with a portable phone (not illustrated), a smart phone (not illustrated), a tablet PC (not illustrated), or other devices (not illustrated), which have a phone number corresponding to a number input into the portable terminal 100.

The sub-communication module 130 includes at least one of the wireless LAN module 131 and the short-distance communication module 132. For example, the sub-communication module 130 includes only the wireless LAN module 131, includes only the short-distance communication module 132, or includes both the wireless LAN module 131 and the short-distance communication module 132.

The wireless LAN module 131 is connected to the Internet at a location where a wireless Access Point (AP) (not illustrated) is installed, based on a control of the controller 110. The wireless LAN module 131 supports the wireless LAN standards (IEEE802.11x) of the Institute of Electrical and Electronic Engineers (IEEE). The short-distance communication module 132 wirelessly performs short-distance communication between the portable terminal 100 and an image forming device (not illustrated) based on a control of the controller 110. The short-distance communication scheme includes Bluetooth®, Infrared Data Association (IrDA), WiFi-Direct communication, and an NFC.

The controller 110 transmits a control signal associated with a haptic pattern to an input unit through at least one of the sub-communication module 130 and the wireless LAN module 131.

The portable terminal 100 includes at least one of the mobile communication module 120, the wireless LAN module 131, and the short-distance communication module 132, depending on performance. Depending on the performance, the portable terminal 100 includes a combination of the mobile communication module 120, the wireless LAN module 131, and the short-distance communication module 132. In the present invention, at least one of or a combination of the mobile communication module 120, the wireless LAN module 131, and the short-distance communication module 132, is referred to as a transceiving unit, which does not reduce the scope of the present invention.

The multimedia module 140 includes the broadcasting communication module 141, the audio playback module 142, or the moving picture playback module 143. The broadcasting communication module 141 receives a broadcasting signal (for example, a TV broadcasting signal, a radio broadcasting signal, or a data broadcasting signal) and broadcasting subsidiary information (for example, an Electric Program Guide (EPG) or an Electric Service Guide (ESG)) transmitted from a broadcasting station, through a broadcasting communication antenna (not illustrated), based on a control of the controller 110. The audio playback module 142 plays back a stored or received digital audio file (of which a file extension is mp3, wma, ogg, or way) based on a control of the controller 110. The moving picture playback module 143 plays back a stored or received digital moving picture file (of which a file extension is mpeg, mpg, mp4, avi, mov, or mkv) based on a control of the controller 110. The moving picture playback module 143 plays back a digital audio file.

The multimedia module 140 includes the audio playback module 142 and the moving picture playback module 143, excluding the broadcasting communication module 141. The audio playback module 142 or the moving picture playback module 143 of the multimedia module 140 is included in the controller 110.

The camera module 150 includes at least one of the first camera 151 and the second camera 152 that captures a still image or a moving picture based on a control of the controller 110. The camera module 150 includes at least one of the body tube 155 that performs zooming in/out for capturing a subject, the motor unit 154 that controls a movement of the body tube 155, and the flash 153 that provides an auxiliary light source required for capturing a subject. The first camera 151 is disposed on a front side of the portable terminal 100, and the second camera 152 is disposed on a back side of the portable terminal 100. In another example, the first camera 151 and the second camera 152 are disposed close to each other (for example, a distance between the first camera 151 and the second camera 152 is greater than 1 cm and less than 8 cm) and thus, a three-dimensional (3D) still image or a 3D moving picture is captured.

The first and the second cameras 151 and 152 include a lens system and an image sensor. Each of the first and the second cameras 151 and 152 converts an optical signal input (captured) through a lens system into an electric image signal and outputs the image signal to the controller 110, and a user may capture a moving picture or a still image through the first and the second cameras 151 and 152.

The GPS module 157 receives an electric wave from a plurality of GPS satellites (not illustrated) in the Earth's orbit, and calculates a location of the portable terminal 100 based on a Time Of Arrival (TOA) from a GPS satellite (not illustrated) to the portable terminal 100.

The input/output module 160 includes at least one of the plurality of buttons 161, the microphone 162, the speaker 163, the vibration motor 164, the connector 165, the keypad 166, the earphones connecting jack 167, the input unit 168, and the detachment recognition switch 169. The input/output module is not limited thereto, and a cursor controller such as a mouse, a track ball, a joystick, or cursor direction keys is provided for controlling a movement of a cursor on the touch screen 190.

The button 161 is formed on a front side, a lateral side, or a back side of a housing of the portable terminal 100, and includes at least one of a power button (not illustrated), a lock button (not illustrated), a volume button (not illustrated), a menu button, a home button, a back button, and a search button 161.

The microphone 162 receives an input of a voice or a sound, and generates an electric signal, based on a control of the controller 110.

The speaker 163 outputs, to the outside of the portable terminal 100, a sound corresponding to a variety of signals (for example, a wireless signal, a broadcasting signal, a digital audio file, a digital moving picture file, and an image capturing signal) of the mobile communication module 120, the sub-communication module 130, the multimedia module 140, or the camera module 150, and a sound corresponding to a control signal provided to an input unit through Bluetooth®, based on a control of the controller 110. The sound corresponding to the control signal includes a sound associated with activation of a vibration device 520 of the input unit 168, a sound of which a volume varies based on a vibration intensity, and a sound associated with deactivation of the vibration device 520.

The speaker 163 outputs a sound corresponding to a haptic pattern generated by shaking or tapping on the portable terminal. The volume of the sound is controlled based on a vibration intensity of the vibration device 520 of the input unit 168 or the sound is output through the speaker 163 of the portable terminal 100 and/or a speaker (not illustrated) included in the input unit 168 when activating the vibration device 520 or a time interval (for example, 10 ms) before/after the activation. The sound is terminated when deactivating the vibration device 520 or a time interval (for example, 10 ms) before/after the deactivation. The speaker 163 outputs a sound (for example, a button manipulation sound corresponding to a phone call or a ring-back tone) corresponding to a function performed by the portable terminal 100. One or a plurality of speakers 163 is formed on an appropriate location or locations of the housing of the portable terminal 100.

The vibration motor 164 converts an electric signal into a mechanical vibration based on a control of the controller 110. For example, when the portable terminal 100 in a vibration mode receives a voice call from another device (not illustrated), the vibration motor 164 operates. One or a plurality of vibration motors 164 is formed in the housing of the portable terminal 100. The vibration motor 164 operates in response to a touch motion of a user who touches the touch screen 190 or successive motions of a touch on the touch screen 190. The vibration motor 164 vibrates based on a haptic pattern generated by shaking the portable terminal or tapping on the portable terminal, and the haptic pattern corresponds to a tactile sensation (for example, vibration, and waving).

The connector 165 is used as an interface for connecting the portable terminal 100 and an external device (not illustrated) or a power source (not illustrated). Based on a control of the controller 110, data stored in the storage unit 175 of the portable terminal 100 is transmitted to an external device (not illustrated) or data is received from an external device (not illustrated) through a wired cable connected to the connector 165. Through the wired cable connected to the connector 165, power is input from a power source (not illustrated) or a battery (not illustrated) is charged using the power source.

The keypad 166 receives a key input from the user for controlling the portable terminal 100. The keypad 166 includes a physical keypad (not illustrated) formed on the portable terminal 100 or a virtual keypad (not illustrated) displayed on the touch screen 190. The physical keypad (not illustrated) formed on the portable terminal 100 is excluded depending on the performance or a configuration of the portable terminal 100.

Earphones (not illustrated) are inserted into the earphone connecting jack 167 for connection with the portable terminal 100, and the input unit 168 is inserted into the portable terminal 100 for storage. When used, the earphones are taken out of or detached from the portable terminal 100. In a portion of the inside of the portable terminal 100 into which the input unit 168 is inserted, a detachment recognition switch 169 that operates in response to attachment and detachment of the input unit 168 is included, so that a signal corresponding to the attachment and detachment of the input unit 168 is provided to the controller 110. The detachment recognition switch 169 is included in the portion into which the input unit 168 is inserted and thus, may directly or indirectly be in contact with the input unit 168 when the input unit 168 is attached. Accordingly, the detachment recognition switch 169 generates a signal corresponding to the attachment or detachment of the input unit 168 based on the direct or indirect contact with the input unit 168, and provides the generated signal to the controller 110.

The sensor module 170 includes at least one sensor that detects a state of the portable terminal 100. For example, the sensor module 170 includes a proximity sensor to detect a proximity of the user to the portable terminal 100, an illuminance sensor (not illustrated) to detect an amount of light around the portable terminal 100, a motion sensor (not illustrated) to detect a motion of the portable terminal 100 (for example, a rotation of the portable terminal 100, an acceleration or vibration applied to the portable terminal 100, and shaking and tapping on portable terminal 100), a Geo-magnetic sensor (not illustrated) to detect a point of the compass using the geomagnetic field, a gravity sensor to detect a direction of the gravity, and an altimeter to detect an altitude by measuring the atmospheric pressure. The at least one sensor detects the state, and generates a signal corresponding to the detection so as to transmit the generated signal to the controller 110. A sensor of the sensor module 170 is added or removed depending on the performance of the portable terminal 100.

The storage unit 175 stores a signal or data input/output to correspond to an operation of the mobile communication module 120, the sub-communication module 130, the multimedia module 140, the camera module 150, the GPS module 157, the input/output module 160, the sensor module 170, the touch screen 190, based on a control of the controller 110. The storage unit 175 stores a control program and an application for controlling the portable terminal 100 or the controller 110.

The storage unit 175 stores information associated with a vibration intensity and a vibration period of a haptic feedback corresponding to a haptic pattern for providing various haptic effects to the input unit 168 or the portable terminal 100 when a temporary touch or successive touches are performed on the touch screen 190 using the input unit 168. The storage unit 175 stores the haptic pattern generated by the controller 110 and unique sounds of various musical instruments such as a percussion instrument and a wind instrument. As described above, the haptic pattern generated by the controller 110 is generated by at least one pattern from among shaking and tapping on the portable terminal 100.

The term “storage unit” includes the storage unit 175, the ROM 112 and the RAM 113 included in the controller 110, or a memory card (not illustrated) (for example, an SD card and a memory stick) contained in the portable terminal 100. The storage unit includes a non-volatile memory, a volatile memory, a Hard Disk Drive (HDD), or a Solid State Drive (SSD).

The storage unit 175 stores applications having various functions such as a navigation, a video call, a game, and a time-based alarm application, images to provide related Graphical User Interfaces (GUIs), user information, documents, databases or data associated with a touch input processing method, background images required for driving the portable terminal 100 (a menu screen and an idle screen), operating programs, and images captured by the camera module 150.

The storage unit 175 stores a haptic pattern which is generated by shaking or tapping on a portable terminal and which corresponds to a tactile sensation (for example, vibration and waiving) that a user can recognize. The storage unit 175 is a machine (for example, a computer)-readable medium, and the term, machine-readable medium, is defined as a non-transitory medium that provides data to the machine so that the machine performs a function. The storage unit 175 includes a non-volatile medium and a volatile medium. The preceding media corresponds to a type in which instructions transferred through the media are detected by a physical device that reads the instructions through the machine.

The machine-readable medium includes at least one of a floppy disk, a flexible disk, a hard disk, a magnetic tape, a Compact Disc Read-Only Memory (CD-ROM), an optical disc, a punch card, a paper tape, a RAM, a Programmable Read-Only Memory (PROM), an Erasable PROM (EPROM), and a flash-EPROM, but this may not be limited thereto.

The power supply unit 180 supplies power to one battery or a plurality of batteries (not illustrated) disposed on the housing of the portable terminal 100, based on a control of the controller 110. One or a plurality of batteries (not illustrated) provides power to the portable terminal 100. The power supply unit 180 supplies, to the portable terminal 100, power input from an external power source (not illustrated) through the wired cable connected to the connector 165. The power supply unit 180 supplies, to the portable terminal 100, power wirelessly input from the external power source through a wireless charging technology.

The portable terminal 100 includes at least one touch screen that provides a user with user interfaces corresponding to various services (for example, calling, data transmission, broadcasting, and image capturing). Each touch screen transmits, to a corresponding touch screen controller, an analog signal corresponding to at least one touch input on a user interface. As described above, the portable terminal 100 includes a plurality of touch screens, and includes a touch screen controller that receives an analog signal corresponding to a touch for each touch screen. The touch screens is respectively connected to a plurality of housings through a hinge connection, or a plurality of touch screens is placed in a single housing without a hinge connection. The portable terminal 100 according to the present invention, as described above, includes at least one touch screen, and hereinafter, the case of a single touch screen will be described for ease of description.

The touch screen 190 receives an input of at least one touch through a body part of the user (for example, a finger including a thumb) or a touch input unit (for example, a stylus pen and an electronic pen). The touch screen 190 displays a menu for receiving an input of a condition from the user, so as to generate a haptic pattern to be provided to the portable terminal. When an input is provided by a stylus pen or an electronic pen, the touch screen 190 includes a pen recognition panel 191 to recognize the input, and the pen recognition panel 191 may recognize a distance between a pen and the touch screen 190 based on the magnetic field. The touch screen 190 receives an input of successive motions of one touch from among the at least one touch. The touch screen 190 transmits, to the touch screen controller 195, an analog signal corresponding to the successive motions of the input touch.

The touch is not limited to a contact between the touch screen 190 and a body part of the user or a touch input unit, and includes a non-contact (for example, a detectable distance between the touch screen 190 and the body part of the user or the touch input unit without being in contact (for example, approximately 5 mm)). The detectable distance that is detected by the touch screen 190 is changed based on the performance or a configuration of the portable terminal 100. Particularly, the touch screen 190 is configured to output a different value by distinguishing a value detected by a touch event and a value detected by a hovering event (for example, an analog value including a voltage value or a current value) so that a touch event occurring by a contact between the input unit and the body part or the touch input unit, and a non-touch input event (for example, hovering) is distinguished for detection. In addition, it is preferable that the touch screen 190 outputs a different value by distinguishing a detected value based on a distance between the touch screen 190 and a space where a hovering event occurs.

The touch screen 190 is embodied based on varied schemes, such as a resistive, a capacitive, an infrared, or an acoustic wave scheme.

The touch screen 190 includes at least two touch screen panels, each being capable of sensing a touch or an approach by a body part of the user or a touch input unit, so as to sequentially or simultaneously receive an input by the body part of the user and an input by the touch input unit. The at least two touch screen panels provide different output values to a touch screen controller, which recognizes the values input from the at least two touch screen panels as different values. Accordingly, it is distinguished whether an input from the touch screen 190 corresponds to an input by the body part of the user or corresponds to an input by the touch input unit.

In particular, the touch screen 190 is formed in a structure in which a panel that senses an input by a finger or the input unit 168 based on a change in an induced electromotive force and a panel that senses a contact between the touch screen 190 and a finger or the input unit 168 are sequentially layered with or without an interval. The touch screen 190 includes a plurality of pixels, and displays an image through the pixels. The touch screen 190 may use a Liquid Crystal Display (LCD), an Organic Light Emitting Diodes (OLED), or an LED.

The touch screen 190 includes a plurality of sensors that recognize a location when a finger or the input unit 168 is in contact with a surface of the touch screen 190 or is placed at a distance from the touch screen 190. Each of the plurality of sensors is formed in a coil structure, and a sensor layer formed of a plurality of sensors, each having a pattern, may form a plurality of electrode lines. When a contact occurs on the touch screen 190 through a finger or the input unit 168 due to the described structure, a detection signal of which a waveform is modified based on a capacitance between the sensor layer and an input means is generated, and the touch screen 190 transmits the generated detection signal to the controller 110. The distance between the input unit 168 and the touch screen 190 is recognized based on an intensity of the magnetic field formed by a coil 430.

The touch screen controller 195 converts an analog signal received from the touch screen 190 into a digital signal (for example, X and Y coordinates), and transmits the digital signal to the controller 110. The controller 110 controls the touch screen 190 using the digital signal received from the controller 195. For example, the controller 110 performs a control to select or to execute a shortcut icon (not illustrated) or an object displayed on the touch screen 190, in response to a touch event or a hovering event. The touch screen controller 195 is included in the controller 110.

In addition, the touch screen controller 195 detects a value such as a current value output through the touch screen 190, determines a distance between the touch screen 190 and a space where the hovering event occurs, converts a value of the determined distance into a digital signal (for example, a Z coordinate) and provides the digital signal to the controller 110.

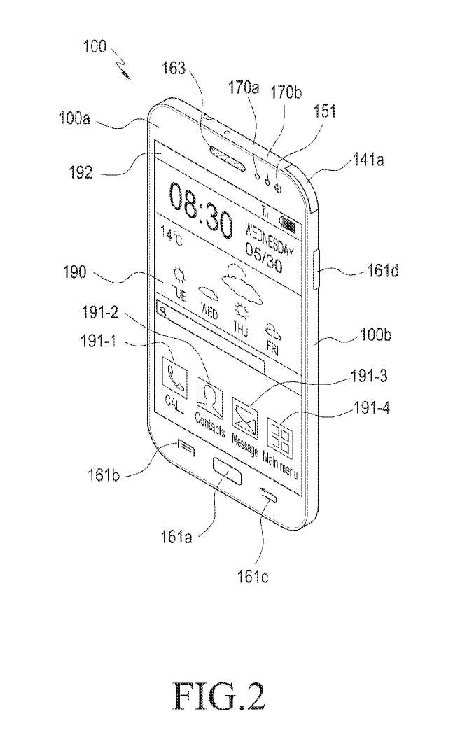

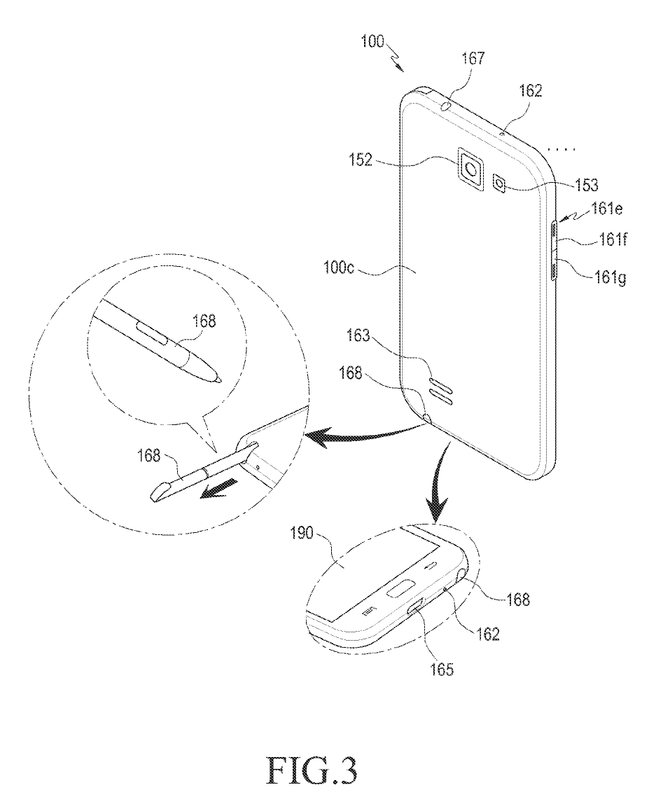

FIG. 2 is a front perspective view of a portable terminal according to an embodiment of the present invention, and FIG. 3 is a back perspective view of a portable terminal according to an embodiment of the present invention.

Referring to FIGS. 2 and 3, the touch screen 190 is disposed in the center of a front side 100a of the portable terminal 100. The touch screen 190 is formed to be large so as to occupy most of the front side 100a of the portable terminal 100. FIG. 2 illustrates an example of the touch screen 190 that displays a main home screen, which is the first screen displayed on the touch screen 190 when the portable terminal 100 is turned on. When the portable terminal 100 has a few pages of different home screens, the main home screen is the first home screen from among the few pages of home screens. In a home screen, shortcut icons 191-1, 191-2, and 191-3 for executing frequently used applications, a main menu switching key 191-4, the time, and the weather are displayed. The main menu switching key 191-4 displays a menu screen on the touch screen 190. A status bar 192 displaying a status of the device 100, such as a battery charging status, an intensity of a received signal, and the current time, is formed on an upper end of the touch screen 190.

A home button 161a, a menu button 161b, and a back button 161c are formed in a lower portion of the touch screen 190.

The home button 161a enables a main home screen to be displayed on the touch screen 190. For example, the main home screen is displayed on the touch screen 190 when any home screen that is different from the main home screen or a menu screen is displayed on the touch screen 190, when the home key 161a is touched. When the home button 191a is touched while applications are executed on the touch screen 190, the main home screen illustrated in FIG. 2 is displayed on the touch screen 190. The home button 161a enables recently used applications to be displayed on the touch screen 190 or is used for displaying a task manager.

The menu button 161b provides a link menu that is used on the touch screen 190. The link menu includes a widget add, a background change, a search, an edit, and a setting menu.

The back button 161c displays a screen that is executed immediately before a currently executed screen or terminates the most recently used application.

The first camera 151, an illuminance sensor 170a, and a proximity sensor 170b is disposed. On a back side 100c of the portable terminal 100, the second camera 152, the flash 153, the speaker 163 are disposed on an edge of the front side 100a of the portable terminal 100

A power/reset button 160a, a volume button 161b, a terrestrial DMB antenna 141a for receiving broadcast, and one or a plurality of microphones 162 are disposed on a lateral side 100b of the portable terminal 100, for example. The DMB antenna 141a is fixed on the portable terminal 100, or is formed to be detachable.

The connector 165 is formed on a lateral side of a lower end of the portable terminal 100. A plurality of electrodes is formed on the connector 165, and is wire connected to an external device. The earphone connecting jack 167 is formed on a lateral side of an upper end of the portable terminal 100. The earphones are insertable into the earphones connecting jack 167.

The input unit 168 is formed on the lateral side of the lower end of the portable terminal 100. The input unit 168 is inserted into the portable terminal 100 for storage, and is taken out from and detached from the portable terminal 100 when it is used.

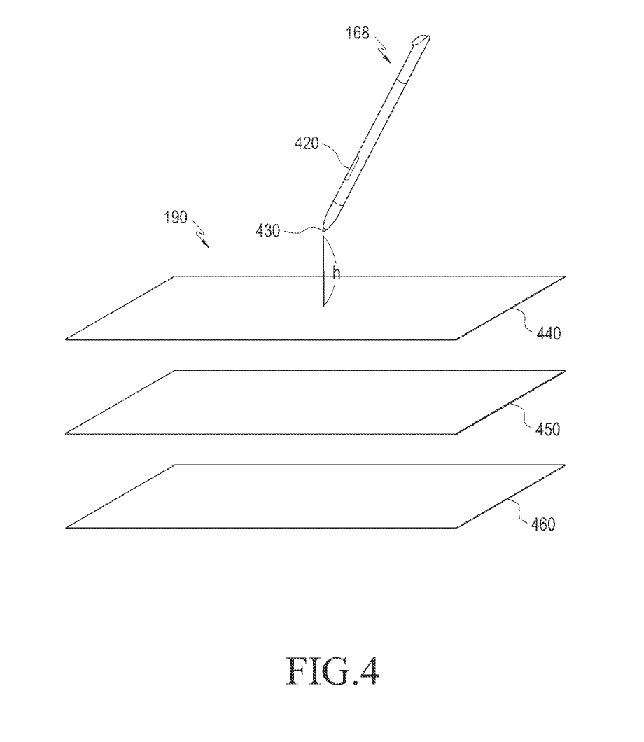

FIG. 4 illustrates an input unit and a view of a touch screen according to an embodiment of the present invention

As illustrated in FIG. 4, the touch screen 190 includes a display panel 440, a first touch panel 450, and a second touch panel 460. The display panel 440 may correspond to an LCD panel or an Active-Matrix Organic Light-Emitting Diode (AMOLED) panel, and displays various operation states of the portable terminal 100 and various images and a plurality of objects associated with execution of applications and services.

The first touch panel 450 is a capacitive touch panel, and has two faces of a pane of glass that are coated with a thin metal conductive material (for example, an ITO (Indium Tin Oxide) film) so that a current flows through a surface of the pane of glass, and is coated with a dielectric substance that is capable of storing an electric charge. When a surface of the first touch panel 450 is touched by an input unit (for example, a finger of a user or a pen), an amount of electric charge moves to a location of the touch by static electricity, and the first touch panel 450 recognizes a variation in a current based on the movement of the electric charge, and senses the location of the touch. The first touch panel 450 senses all touches that generate static, and senses a touch by a finger or a pen which corresponds to an input unit.

The second touch panel 460 is an ElectroMagnetic Radiation (EMR) touch panel, and includes an electromagnetic induction coil sensor (not illustrated) having a grid structure in which a plurality of loop coils are disposed in a first direction which is determined in advance and a plurality of loop coils are disposed in a second direction which intersects with the first direction, and includes an electronic signal processing unit (not illustrated) that sequentially provides an Alternating Current (AC) signal having a frequency to each loop coil of the electromagnetic induction coil sensor. When the input unit 168 containing a resonant circuit exists around a loop coil of the second touch panel 460, a magnetic field transmitted from the corresponding loop coil generates a current in the resonant circuit of the input unit 168 based on mutual electromagnetic induction.

Based on the current, an induction field is generated from a coil (not illustrated) that forms the resonant circuit of the input unit 168, and the second touch panel 460 detects the induction field from a loop coil which is in a state of receiving a signal and senses a hovering location of the input unit 168, a touch location, and a height (h) from the display panel 440 of the portable terminal 100 to a pen point 430 of the input unit 168. It is apparent to those skilled in the art that the height from the display panel 440 of the touch screen 190 to the pen point 430 is variable based on the performance or structure of the portable terminal 100.

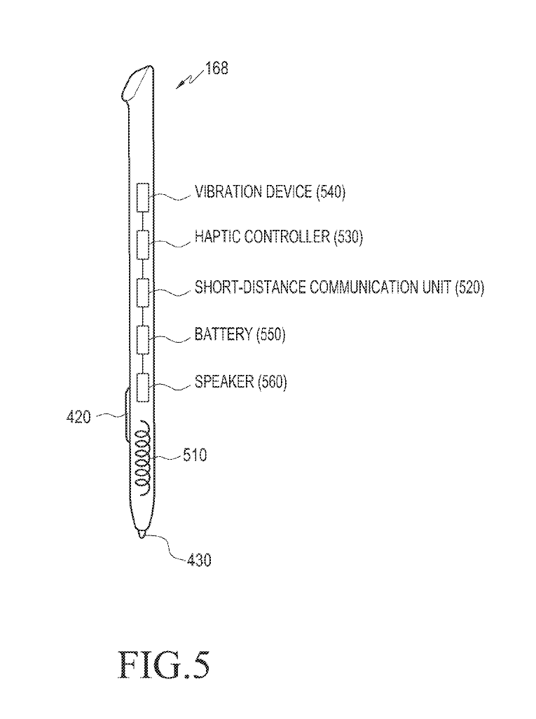

In an input unit that is capable of generating an electromagnetic induction-based current, a hovering and a touch are sensed through the second touch panel 460. It is described that the second touch panel 460 is used for only sensing a hovering or a touch by the input unit 168. The input unit 168 is referred to as an electromagnetic pen or an ElectroMagnetic Radiation (EMR) pen. The input unit 168 is different from a general pen that excludes a resonant circuit sensed by the first touch panel 450. The input unit 168 is configured to include a button 420 that is capable of changing an electromagnetic induction value generated by a coil disposed inside an area of a penholder which is adjacent to the pen point 430. The input unit 168 will be described in detail with reference to FIG. 5.

The touch screen controller 195 includes a first touch panel controller (not shown) and a second touch panel controller (not shown). The first touch panel controller converts an analog signal received from the first touch panel 450 by sensing a touch by a hand or a pen, into a digital signal (for example, X, Y, and Z coordinates), and transmits the digital signal to the controller 110. The second touch panel controller converts an analog signal received from the second touch panel 460 by sensing a hovering or a touch by the input unit 168, into a digital signal, and transmits the digital signal to the controller 110. The controller 110 controls the display panel 440, the first touch panel 450, and the second touch panel 460 using digital signals received from the first and the second touch panel controllers. For example, the controller 110 enables a screen of a figure to be displayed on the display panel 440 in response to a hovering or a touch of a finger, a pen or the input unit 168.

According to the portable terminal 100, the first touch panel senses a touch by a finger of a user or a pen, and the second touch panel senses a hovering or a touch by the input unit 168. Therefore, the controller 110 of the portable terminal 100 performs sensing by distinguishing a touch by a finger of the user or a pen and a hovering or a touch by the input unit 168. Although FIG. 4 merely illustrates a single touch screen, the present invention is not limited to a single touch screen and includes a plurality of touch screens. The touch screens are respectively included in housings and are connected by a hinge, or the plurality of touch screens is included in a single housing. Each of the plurality of touch screens is configured to include a display panel and at least one touch panel, as illustrated in FIG. 4.

FIG. 5 is a block diagram illustrating an input unit that provides a haptic effect according to an embodiment of the present invention.

Referring to FIG. 5, an input unit (for example, a touch pen) is configured to include a penholder, a pen point 430 disposed on an end of the penholder, a button 420 that is capable of changing an electromagnetic induction value generated by a coil 510 disposed inside an area of the penholder which is adjacent to the pen point 430, a vibration device 540 that vibrates when a hovering input effect occurs, a haptic controller 530 that analyzes a control signal received from the portable terminal 100 through a hovering with the portable terminal 100, and controls a vibration intensity and a vibration period of the vibration device 520 to provide a haptic effect to the input unit 168, a short-distance communication unit 520 that performs short distance communication with the portable terminal 100, and a battery 550 that supplies power for vibration of the input unit 168.

The input unit 168 further includes a speaker 560 that outputs a sound corresponding to a vibration period and/or a vibration intensity of the input unit 168. The speaker 560 outputs, to the speaker 163 included in the portable terminal 100, a sound corresponding to the haptic effect provided to the input unit 168, simultaneously or a period of time (for example, 10 ms) before/after the provision of the haptic effect.

In particular, the speaker 560 outputs a sound corresponding to a variety of signals (for example, a wireless signal, a broadcasting signal, a digital audio file, and a digital moving picture file) of the mobile communication module 120, the sub-communication module 130, or the multimedia module 140 included in the portable terminal 100, based on a control of the controller 110. The speaker 560 outputs a sound (for example, a button manipulation sound corresponding to a phone call or a ring-back tone) corresponding to a function performed by the portable terminal 100. One or a plurality of speakers 560 is formed on an appropriate location or locations of the housing of the input unit 168.

The haptic controller 530 activates the short-distance communication unit 520 and the vibration device 540, when the input unit 168 is in contact with the touch screen 190 of the portable terminal 100 or is located within a distance adjacent to the touch screen 190 of the portable terminal 100 or at least one control signal is received from the portable terminal 100. The controller 530 deactivates the vibration device 520 when the input unit 168 is not located adjacent to the touch screen 190 of the portable terminal 100, or vibration is completed by receiving at least one control signal from the portable terminal 100.

The touch screen 190 senses a location of the input unit 168. That is, when the input unit 168 is located adjacent to a surface of the touch screen 190 or is in contact with the surface of the touch screen 190, an amount of electric charge moves to the adjacent location by static electricity and the touch screen 190 recognizes a variation in a current based on the movement of the electric charge, and senses the adjacent location or the location of the contact.

The haptic controller 530 analyzes at least one control signal received from the portable terminal 100 through the short-distance communication unit 520 when the pen point 430 has a contact with the touch screen 190 or is placed on the touch screen 190, and controls a vibration period and a vibration intensity of the vibration device 540 included in the input unit 168 based on the analyzed control signal. The control signal is transmitted by the portable terminal 100, and is periodically transmitted to the input unit 168 during a period of time or until a touch is finished. The control signal includes information associated with a waveform of a haptic pattern generated by shaking or tapping on the portable terminal 100.

The input unit 168 as described above is configured to support an electrostatic inductive scheme. The touch screen 190 is configured to detect a location of a magnetic field and to recognize a touch point when the magnetic field is formed at a point of the touch screen 190 by the coil 510.

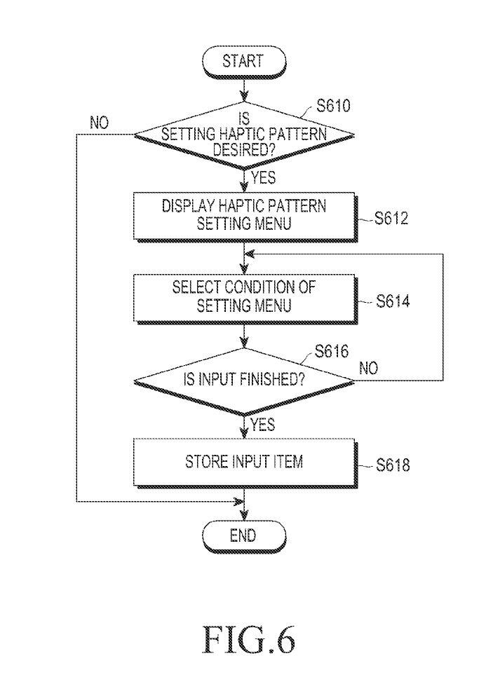

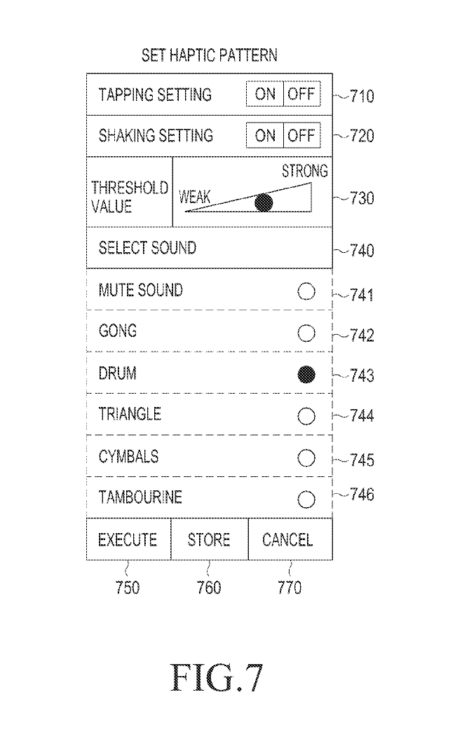

FIG. 6 illustrates a method of setting a haptic pattern according to an embodiment of the present invention, and FIG. 7 illustrates an example of setting a haptic pattern according to an embodiment of the present invention.

To set a haptic pattern to be provided to a portable terminal, a menu for setting a haptic pattern is displayed in steps S610 and S612. In this example, the portable terminal is in a state of playing back an object such as a moving picture, or in an idle state in which an object is not played back. The menu corresponds to an application dedicated for generating a haptic pattern or a basically provided function such as settings of a portable terminal. The menu, as illustrated in FIG. 7, includes a shaking setting associated with shaking a portable terminal, a tapping setting associated with tapping on a portable terminal, a threshold value for sensing a haptic input of a portable terminal, and a musical instrument setting associated with a musical instrument to be applied to a haptic pattern (for example, a percussion instrument, a wind instrument, and a string instrument). A haptic input provided to the portable terminal is generated by shaking or tapping on the portable terminal.

In particular, the menu includes a tapping setting 710 for generating a haptic pattern corresponding to tapping on a portable terminal, a shaking setting 720 for generating a haptic pattern corresponding to shaking a portable terminal, and a threshold value setting 730 for sensing a setting when at least one of the menus 710 and 720 is selected, and a sound selection 740. One or both of the tapping setting 710 and the shaking setting 720 are selected. The sound selection selects a sound of a percussion musical instrument such as a gong 742, a drum 743, a triangle 744, a cymbal 745, and a tambourine 746, a sound of a sting instrument such as a violin, a cello, a viola, a gayageum, and a geomungo, or a mute sound 741.

The present invention is applicable to various wind instruments in addition to the described percussion and string instruments, and one or more musical instruments are selected. The threshold value setting 730 sets a value for sensing shaking or tapping when shaking or tapping on the portable terminal 100 occurs. When the threshold value is set to be strong, shaking and tapping are sensed even when a slight shaking and tapping on the portable terminal occur. When the threshold value is set to be weak, shaking and tapping are more broadly sensed. For example, a threshold value of a speed is set to 3 m/s for the case of shaking the portable terminal, and a threshold value of a collision is set to 0.01N for the case of tapping on the portable terminal, and the described threshold values is changed. Shaking and tapping less than the threshold values are recognized as shaking and tapping occurring in everyday life and thus, the sensor module 170 may disregard them.

At least one input is selected from the displayed menu in step S614. That is, the tapping setting 710 is set to “ON” to generate a haptic pattern by tapping on the portable terminal, and the shaking setting 720 is set to “ON” to generate a haptic pattern by shaking the portable terminal. When shaking and tapping on the portable terminal are performed in parallel, the two menus are set to “ON”. A threshold value for sensing tapping or shaking performed for generating a haptic pattern is set (for example, 3 m/s for shaking and 0.01N for tapping). A sound is then selected that is provided simultaneously when a haptic input is provided to the portable terminal through the generated haptic pattern. The sound selection 740 is set to be the mute sound 741 or designates an instrument sound such as the gong 742, the drum 743, the triangle 744, the cymbal 745, and the tambourine 746.

FIG. 7 illustrates when the drum 743 is selected. Musical instrument sounds corresponding to a plurality of musical instruments are stored in the storage unit 175 in advance. After the tapping setting 710 or the shaking setting 720 is designated, when a user taps on the portable terminal or shakes the portable terminal, the sensor module 170 measures a haptic input, and the controller 110 calculates an intensity of tapping or a speed and/or an acceleration of shaking based on a measurement result.

In particular, when a haptic input of tapping the portable terminal 100 at least one time is input, the portable terminal 100 measures an intensity of tapping and compares the measured intensity to a threshold value (for example, 0.01N). The threshold value setting 730 is determined or determined in advance based on a sensitivity of the sensor module 170 of the portable terminal for sensing a speed, an acceleration, and an impact, and a threshold value for tapping and a threshold value for shaking are set, respectively. A haptic input is generated based on an intensity of tapping that exceeds the threshold value as a result of the comparison. When a haptic input of shaking the portable terminal at least one time is input, a speed or an acceleration of shaking the portable terminal 100 is measured and the measured speed or acceleration is compared to a threshold value (for example, 3 m/s). The threshold value is set by the user in step 730 of FIG. 7 or is designated in advance. A haptic pattern is generated based on a speed/acceleration that exceeds the threshold value, as a result of the comparison.

Referring back to FIG. 6, when the input is completed, an input item is stored in step S616 and S618. The input item and a haptic pattern generated by shaking or tapping on the portable terminal 100 are displayed to the user or executed before being stored, and are stored after an editing process to suit a user. As described above, to edit the generated haptic pattern, the generated haptic pattern is displayed or executed by selecting an execution button 750. After editing the generated haptic pattern, the haptic pattern is stored by selecting a storing button 760. That is, the haptic pattern generated through the described processes is executed before being stored so that a period and a vibration intensity of the haptic input is edited to suit a user's taste. In this example, the execution button 750 is selected. The cancellation button 770 is selected to cancel the generated haptic pattern.

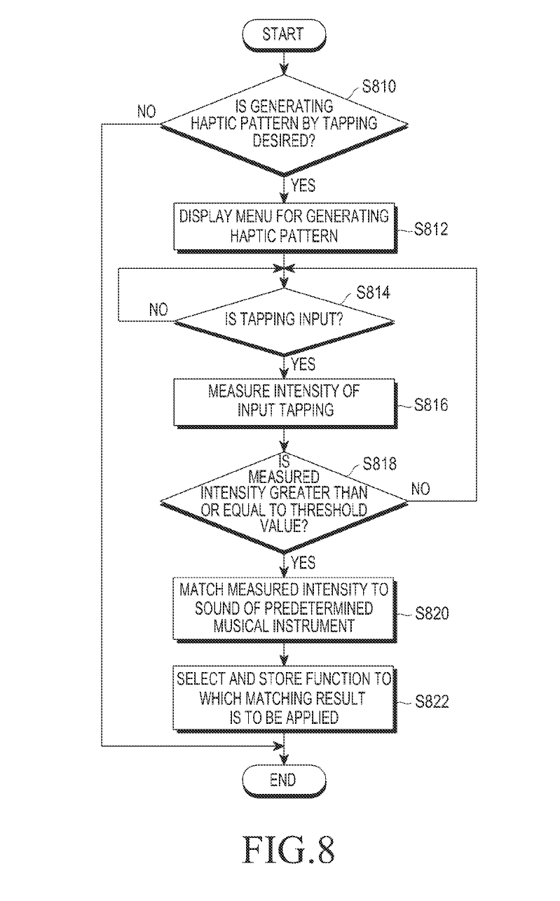

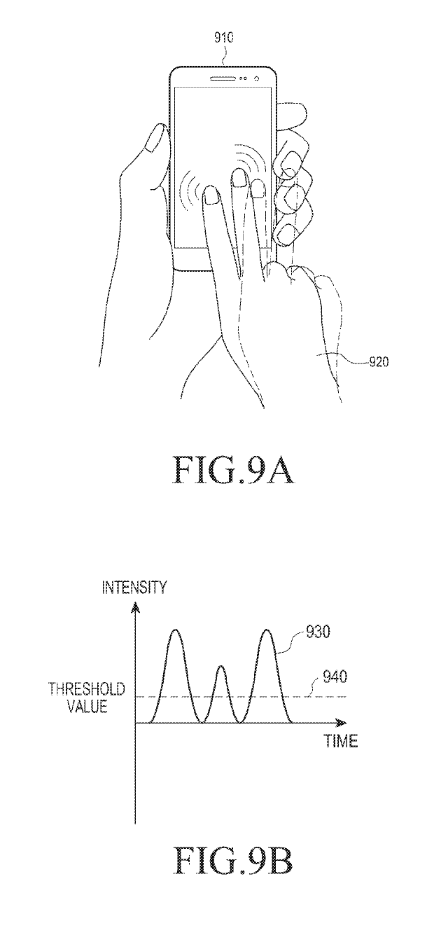

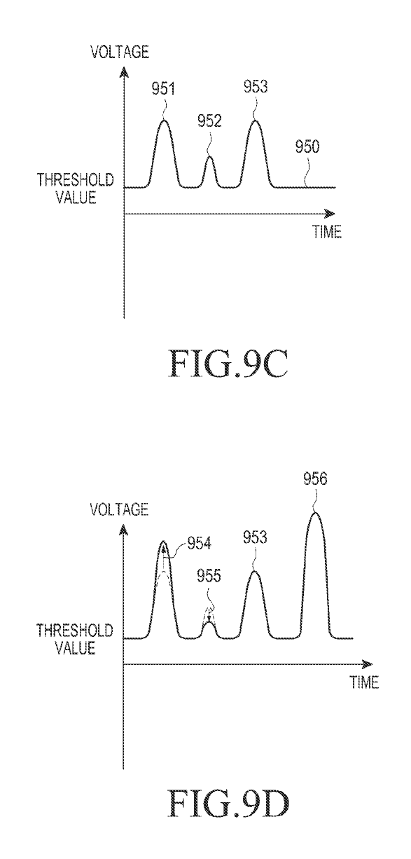

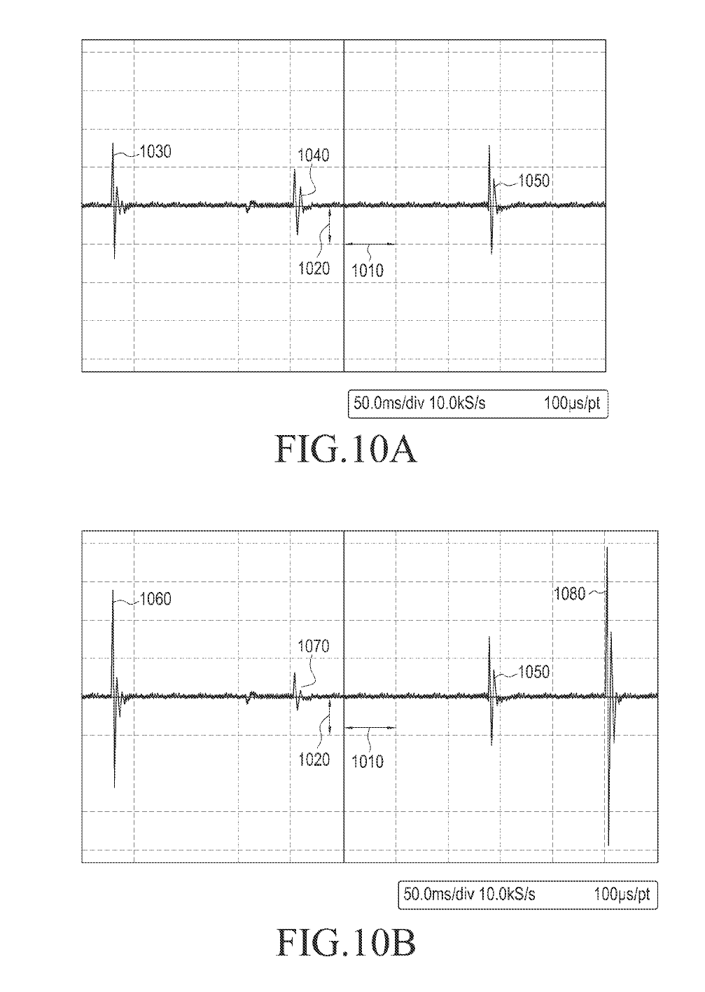

FIG. 8 illustrates a process of generating a haptic pattern by tapping on a portable terminal according to an embodiment of the present invention. FIGS. 9A through 9D illustrate examples of generating a haptic pattern by tapping on a portable terminal according to an embodiment of the present invention. FIGS. 10A through 10B illustrate a waveform of a haptic pattern generated by tapping on a portable terminal according to an embodiment of the present invention.

FIG. 9A illustrates an example of tapping on a portable terminal according to an embodiment of the present invention, FIG. 9B illustrates an example of a change in an intensity of tapping when tapping on a portable terminal according to an embodiment of the present invention, FIG. 9C is a graph illustrating a voltage associated with an intensity of tapping that exceeds a threshold value when tapping on a portable terminal according to an embodiment of the present invention, and FIG. 9D illustrates an example of a result of editing a haptic waveform generated by tapping on a portable terminal according to an embodiment of the present invention.

FIG. 10A illustrates a waveform of a haptic pattern, before editing the haptic pattern generated by tapping on a portable terminal, and FIG. 10B illustrates a waveform of a haptic pattern after editing the haptic pattern generated by tapping on the portable terminal.

Referring back to FIG. 8, to generate a haptic input by tapping on the portable terminal, a menu for setting a haptic pattern is displayed in steps S810 and S812. As illustrated in FIG. 7, the menu includes a shaking setting associated with shaking a portable terminal, a tapping setting associated with tapping on a portable terminal, a sensitivity setting for setting a threshold value for sensing an input pattern of a portable terminal, and a musical instrument setting associated with a musical instrument to be applied to a haptic pattern.

When at least one condition such as a tapping setting, a threshold setting, and a sound selection, is input through the displayed menu, and tapping on one side of the portable terminal is input, an intensity of the input tapping is measured in steps S814 and S816. The present invention provides a touch screen with a separate area to which tapping is to be input, and the area is displayed when the menu is executed. Tapping is input when at least one condition is input after the menu is displayed or when an object such as a movie is displayed. The object is executed or played back when a menu for generating a haptic input is executed. When a haptic input is input by tapping when the object such as a movie is displayed, the portable terminal synchronizes an input time when the haptic input is input and a playback time of the displayed movie, and matches the provided haptic input to the displayed movie and stores the matched information.

The at least one condition includes the threshold value setting 730 for setting a sensitivity of a sensor module that senses tapping when tapping on the portable terminal, and includes a sound selection for selecting a sound to be provided together with a vibration when the portable terminal is vibrated as a haptic feedback corresponding to a haptic pattern. The menu to select the sound includes a mute sound and includes sounds of various musical instruments in addition to a percussion instrument such as a gong, a drum, a triangle, a cymbal, and a tambourine, a wind instrument, and a sting instrument. An intensity of input tapping is measured and the measured intensity is compared to a threshold value. Tapping is provided on one side of the portable terminal, and tapping is performed by a finger, for example. A haptic input of tapping on the portable terminal is recognized.

FIG. 9A illustrates an example of tapping on a portable terminal, and the portable terminal senses tapping provided by a finger 920 or an input unit. An input by tapping includes a single touch or a multi-touch provided by the finger or the input unit. In this example, the portable terminal displays, on the touch screen 910, an object such as a movie or an object such as a document, an e-mail, and image, when a menu or an application for generating a haptic pattern is executed, and a haptic pattern is input by tapping on the portable terminal in this state. As described above, when a haptic input is input, the portable terminal applies the haptic input to a currently displayed object and stores the same.

When the measured intensity is greater than or equal to the threshold value in step S816, a sound of a musical instrument is matched to the intensity greater than or equal to the threshold value in steps S818 and S820. When tapping on the portable terminal, an intensity of tapping is different for each case and a pattern of tapping is also different for each case. That is, tapping on the portable terminal is input at a tempo and with different intensities.

Unintentional tapping may occur. As described above, the reason for setting the threshold value for recognizing tapping is to not recognize unintentionally provided tapping as tapping when unintentional tapping occurs. When tapping is input, an intensity of input tapping is compared to the threshold value. An intensity of tapping that exceeds the threshold value is changed into a voltage signal, which is changed into a vibration signal. A haptic pattern is generated by matching a sound of a musical instrument to the voltage signal.

FIG. 9B illustrates an example of an intensity 930 of tapping when tapping on the portable terminal. A graph is formed based on a tapping intensity. A waveform representing an intensity of tapping is classified into when the intensity is greater than the threshold value 940 and when the intensity is less than the threshold value 940.

FIG. 9C illustrates a waveform 950 associated with an intensity of tapping that exceeds the threshold value when tapping on the portable terminal, and intensities that exceed the threshold value are changed into voltage signals. In FIG. 9C, tapping occurs a total of three times, and a waveform 951 of a first tapping and a waveform 953 of a third tapping are greater than a waveform 952 of a second tapping.

As illustrated in FIG. 9D, an intensity of tapping that exceeds the threshold value is edited by a user, and it is performed by displaying a waveform corresponding to at least one of FIGS. 9B through 9D on a touch screen, and receiving an edition on the displayed waveform from the user. For example, as illustrated in FIG. 9D, the waveform 951 of the first tapping of FIG. 9C is amplified to a waveform 954 of FIG. 9D and the waveform 952 of the second tapping of FIG. 9C is reduced to a waveform 955 of FIG. 9D. A waveform 956 of FIG. 9D is newly added although the waveform 953 of the third tapping of FIG. 9C has no change in a waveform 956 of FIG. 9D.

As described above, the present invention displays a generated haptic pattern on the touch screen 190, and edits a vibration intensity and a vibration period of a haptic input generated when the user taps on the portable terminal, through a touch of a maximum value of each voltage by an input unit or a finger, so that an intensity of a voltage is edited to be high or low. In addition, the new waveform 956 is added.

FIG. 10 illustrates a waveform of a haptic pattern generated by tapping on the portable terminal.

Referring to FIG. 10, FIG. 10A illustrates a waveform of a haptic pattern generated by tapping on the portable terminal, and FIG. 10B illustrates a waveform after editing the haptic pattern generated in FIG. 10A. In FIG. 10A and FIG. 10B, the horizontal axis (i.e, X-axis) indicates a strength of the waveform of the haptic pattern, and the vertical axis (i.e., Y-axis) indicates time. Furthermore, the space 1010 of the horizontal axis indicates 50 ms, and the space 1020 of the vertical axis indicates 1 Volt. As illustrated in FIG. 10A, three tapping occurrences 1030, 1040, and 1050 occur. In FIG. 10A and FIG. 10B, a horizontal axis (that is, an X-axis) indicates time, and a vertical axis (that is, an Y-axis) indicates voltage. One grid in the horizontal axis indicates 50 ms, and one grid in the vertical axis indicates 2V. Therefore, it is recognized that a first tapping 1030 has a voltage of approximately 6V, a second tapping 1040 having a voltage of approximately 4V occurs after approximately 160 ms, and a third tapping 1050 having a voltage of approximately 6V occurs after approximately 180 ms. A vibration intensity caused by tapping is edited, and a new vibration intensity is added.

As illustrated in FIG. 10B, the first tapping 1030 having a magnitude of approximately 6V in FIG. 10A is edited and is extended to have an amplitude of approximately 10V, as illustrated in FIG. 10B. The second tapping 1040 having a magnitude of approximately 4V in FIG. 10A is edited and is reduced to have an amplitude of approximately 2V, as illustrated in FIG. 10B. The third tapping 1050 having a magnitude of approximately 6V in FIG. 10A has no change in an amplitude, but a waveform 1080 having a magnitude of approximately 16V is generated, as illustrated in FIG. 10B. As described above, by tapping on the portable terminal, a haptic input is generated and a generated haptic input is edited.

Referring back to FIG. 8, in step S822, a function to which the matching result of step S820 is to be applied is selected, and a result thereof is stored. In step S820, a haptic pattern is generated by matching the measured intensity to a sound of a musical instrument. At least one function to which the generated haptic pattern is to be applied (for example, receiving a call, receiving a text message, searching for/call a telephone number of a person, or locking/unlocking a portable terminal is selected, and a result of the selection is stored. The at least one function includes various functions provided in the portable terminal 100. Subsequently, when a pattern based on tapping is input, the input pattern and a pattern stored in advance are compared and a function corresponding to the input pattern is executed. The haptic pattern is designated for each group or for each person in contacts stored in the portable terminal. The haptic pattern locks or unlocks the portable terminal, and also executes an object. It is apparent that the present invention is applicable to all functions provided in a portable terminal in addition to the described functions.

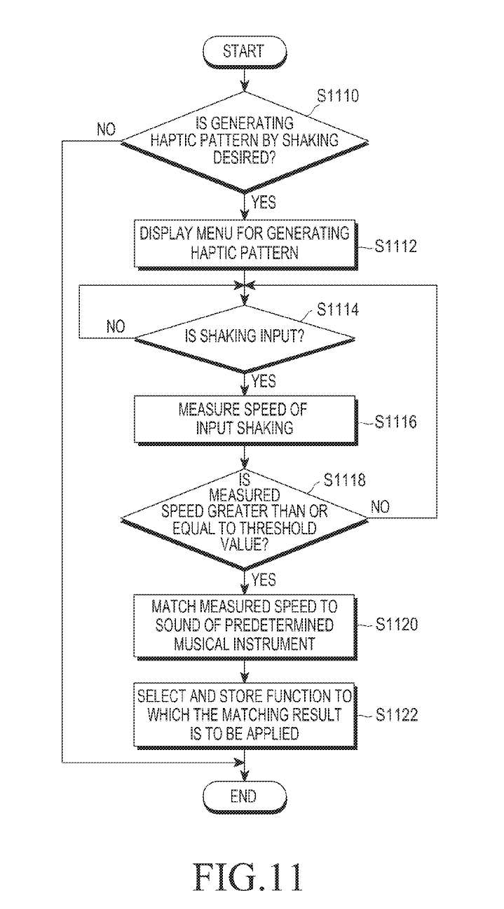

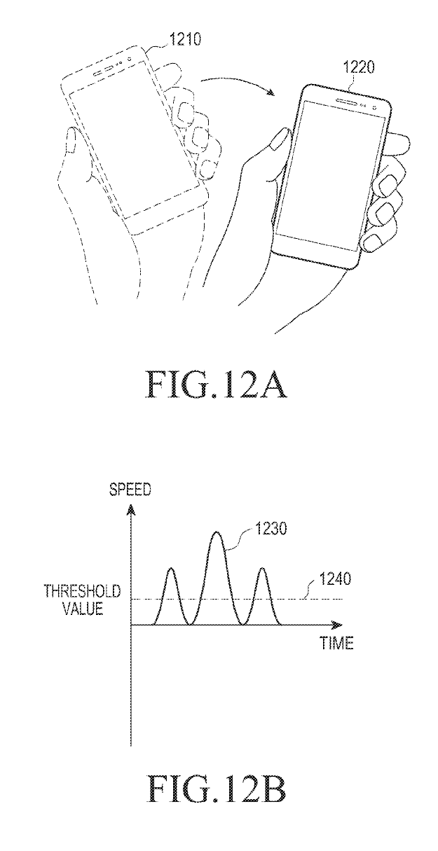

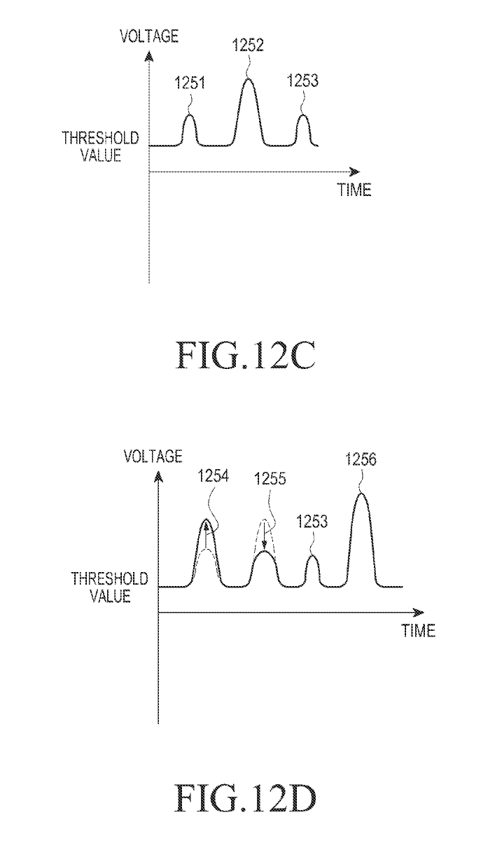

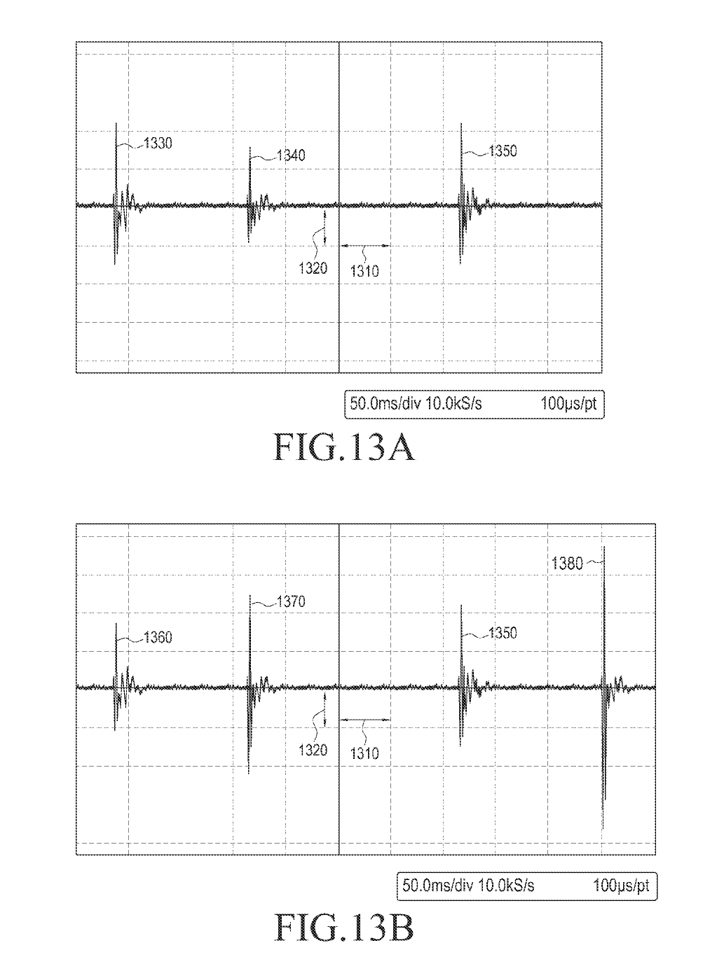

FIG. 11 illustrates a process of generating a haptic pattern by shaking a portable terminal according to an embodiment of the present invention, FIG. 12 illustrates an example of generating a haptic pattern by shaking a portable terminal according to an embodiment of the present invention, and FIG. 13 illustrates a waveform of a haptic pattern generated by shaking a portable terminal according to an embodiment of the present invention.

FIG. 12A illustrates an example of shaking a portable terminal, FIG. 12B illustrates an example of a change in a speed of shaking when shaking a portable terminal, FIG. 12C is a graph illustrating a voltage associated with a speed of shaking that exceeds a threshold value when shaking a portable terminal, and FIG. 12D illustrates an example of a result of editing a haptic waveform generated by shaking a portable terminal, all according to an embodiment of the present invention.

FIG. 13A illustrates a waveform before editing a haptic pattern generated by shaking a portable terminal according to an embodiment of the present invention, and FIG. 13B illustrates a waveform after editing a haptic pattern generated by shaking a portable terminal according to an embodiment of the present invention.

Referring to FIG. 11, to generate a haptic pattern by shaking a portable terminal, a menu for setting a haptic pattern is displayed in steps S1110 and S1112. As illustrated in FIG. 7, the menu includes a shaking setting associated with shaking a portable terminal, a tapping setting associated with tapping on a portable terminal, a sensitivity setting for setting a threshold value for sensing an input pattern of a portable terminal, and a musical instrument setting associated with a musical instrument to be applied to a haptic pattern.

When at least one condition such as a shaking setting, a threshold value setting, and a sound selection is input through the displayed menu, and shaking the portable terminal is input, a speed of the input shaking is measured in steps S1114 and S1116. Shaking is input when at least one condition is input after the menu is displayed or when an object such as a movie is displayed. The object is executed or played back in a state in which the menu for generating a haptic is executed. When the haptic input is input by tapping when the object such as a movie is displayed, the portable terminal may synchronize an input time when the haptic input is input and a playback time of the movie that is displayed, and may match the haptic input to the played back movie, and stores matched information.

The at least one condition includes a threshold value setting for setting a sensitivity of a sensor module that senses shaking when shaking the portable terminal, and includes a sound selection that selects a sound to be provided together with a vibration when the portable terminal is vibrated as a haptic feedback corresponding to the haptic pattern. Shaking is defined as holding and shaking the portable terminal up and down and from side to side, and is measured using at least one of a gyro sensor, a motion sensor, a geo-magnetic sensor, a gravity sensor, and an acceleration sensor included in the sensor module. The portable terminal may recognize a pattern of shaking the portable terminal.

FIG. 11A illustrates an example before shaking the portable terminal, and FIG. 12A illustrates an example after at least one instance of shaking occurs. Shaking is defined as moving the portable terminal from the left side to the right side, and the sensor module 170 senses shaking from the left side to the right side as well as shaking from the right side to the left side. In this example, the portable terminal plays back an object such as a movie, or displays an object such as a document, an e-mail, and an image, and in this state, the portable terminal inputs a haptic pattern by shaking the portable terminal. As described above, when a haptic input of shaking is input, the portable terminal applies the provided haptic input to an object that is currently displayed and stores the same.

In step S1116, when a measured speed of shaking is greater than or equal to a threshold value, a sound of a musical instrument is matched to the speed that is greater than or equal to the threshold value in steps S1118 and S1120. When shaking the portable terminal, a speed or an acceleration of shaking is different for each case, and a pattern of shaking is also different for each case. That is, shaking the portable terminal is input at a tempo and with different speeds or accelerations.

Unintentional shaking may occur. As described above, the reason for setting the threshold value for recognizing shaking is to not recognize unintentionally provided shaking as normal shaking for generating a haptic pattern when unintentional shaking occurs. As described above, when shaking is input, a speed or an acceleration of the input shaking is compared to the threshold value. A speed or acceleration of shaking that exceeds the threshold value is changed into a voltage signal, which is changed into a vibration signal. A haptic pattern is generated by matching a sound of a musical instrument to the voltage signal.

FIG. 12B illustrates a waveform associated with a speed 1230 of shaking. A waveform is formed based on a speed or an acceleration of shaking. A waveform representing a speed of shaking is classified into when the speed is greater than a threshold value 1240 and when the speed is less than the threshold value 1240.

FIG. 12C illustrates a voltage associated with an intensity of shaking that exceeds the threshold value when shaking the portable terminal, and the speed 1230 that exceeds the threshold value is changed into a voltage signal. In FIG. 12C, shaking occurs a total of three times, and a waveform 1251 of a first shaking has the lowest speed and a waveform 1252 of a second shaking has the highest speed. A waveform 1253 of a third shaking has a speed that is lower than the second shaking but higher than the first shaking. As illustrated in FIG. 12C, a speed of shaking that exceeds the threshold value is edited by a user, and is performed by displaying a waveform corresponding to at least one of FIGS. 12B through 12D on a touch screen, and receiving an edition on the displayed waveform from the user.

For example, as illustrated in FIG. 12D, the waveform 1251 of the first shaking of FIG. 12C is amplified to a waveform 1254 of FIG. 12D and the waveform 1252 of the second shaking is reduced to a waveform 1255 of FIG. 12D. Although the waveform 1253 of the third shaking has no change in a waveform 1256 of FIG. 12D, a waveform 1256 is newly added. As described above, the present invention displays a generated haptic pattern on the touch screen 190, and edits a vibration intensity and a vibration period of a haptic input generated when the user shakes the portable terminal, through a touch of a maximum value of each voltage with an input unit or a finger, so that an intensity of a voltage is edited to be high or low. The new waveform 1256 is also added.

FIG. 13 illustrates a waveform of a haptic pattern generated by shaking a portable terminal.

Referring to FIG. 13, FIG. 13A illustrates a waveform of a haptic pattern generated by shaking the portable terminal, and FIG. 13B illustrates a waveform after editing the haptic pattern generated in FIG. 13A. In FIG. 13A and FIG. 13B, the horizontal axis (i.e., X-axis) indicates a strength of the waveform of the haptic pattern, and the vertical axis (i.e., Y-axis) indicates time. Furthermore, the space 1310 of the horizontal axis indicates 50 ms, and the space 1320 of the vertical axis indicates 1 Volt. As illustrated in FIG. 13A, three instances of shaking 1330, 1340, and 1350 occur. In FIG. 13A and FIG. 13B, a horizontal axis (that is, an X-axis) indicates time, and a vertical axis (that is, an Y-axis) indicates voltage. One grid in the horizontal axis indicates 50 ms, and one grid in the vertical axis indicates 2V. Therefore, it is recognized that a first shaking 1330 has a voltage of approximately 7V, a second shaking 1340 having a voltage of approximately 5V occurs after approximately 130 ms, and a third shaking 1350 having a voltage of approximately 7V occurs after approximately 200 ms.

A vibration intensity caused by shaking is edited, and a new vibration intensity is added. As illustrated in FIG. 13B, the first tapping 1330 having a magnitude of approximately 7V in FIG. 13A is edited and is reduced to have an amplitude of approximately 5V, as illustrated in FIG. 10B. The second tapping 1340 having a magnitude of approximately 5V in FIG. 13A is edited and is extended to have an amplitude of approximately 9V, as illustrated in FIG. 13B. The third shaking 1350 having a magnitude of approximately 6V in FIG. 13A has no change in an amplitude, but a waveform 1380 having a magnitude of approximately 14V is generated, as illustrated in FIG. 13B. As described above, by shaking the portable terminal, a haptic input is generated and a generated haptic input is edited.

In step S1122, a function to which the matching result of step S1120 is to be applied is selected and stored. A haptic pattern is generated by matching the measured speed to a sound of a musical instrument. At least one function to which the generated haptic pattern is to be applied (for example, receiving a call, receiving a text message, searching for/call a telephone number of a person, and locking/unlocking a portable terminal) is selected, and a result of the selection is stored. The at least one function includes various functions provided in the portable terminal 100. when a pattern associated with shaking is input, the input pattern and a pattern stored in advance are compared and a function corresponding to the input pattern is executed. The haptic pattern is designated for each group or for each person in contacts stored in the portable terminal The haptic pattern locks or unlocks the portable terminal, and also executes an object. It is apparent that the present invention is applicable to all functions provided in a portable terminal in addition to the described functions.

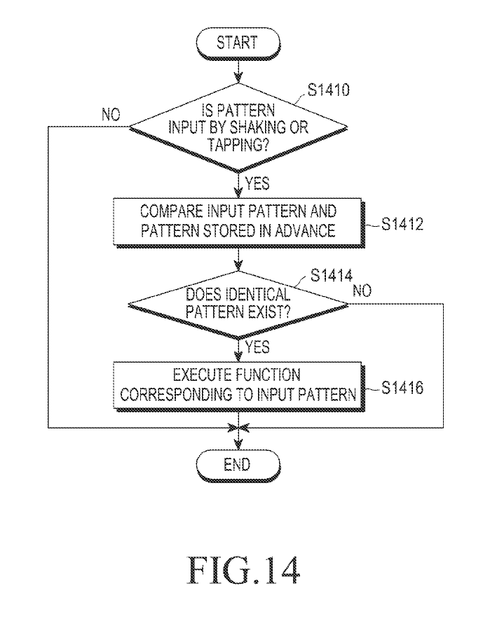

FIG. 14 illustrates a process of executing a previously designated function based on a pattern input to a portable terminal according to an embodiment of the present invention.

When a pattern of shaking or tapping on a portable terminal is input, the input pattern and a haptic pattern stored in advance are compared in steps S1410 and S1412. The pattern occurs when a user shakes the portable terminal up and down or from side to side, or taps on the portable terminal with an input unit such as a finger. A sensor module included in the portable terminal senses whether a speed of shaking the portable terminal is greater than or equal to a speed or whether an intensity of an impact occurring on the portable terminal is greater than or equal to an intensity. The haptic pattern stored in advance is obtained by applying, to at least one function provided in the portable terminal, a speed/acceleration of shaking or an intensity of tapping that exceeds a threshold value from among haptic inputs provided by shaking or tapping on the portable terminal, and storing the same. As described above, whether amplitudes and periods are identical between an input pattern and the haptic input stored in advance is determined. There may generally exist an instance in which two haptic inputs do not match 100%. Accordingly, when they are similar with an error of less than 5%, it is determined that they are identical. The error is variable.

When a haptic pattern stored in advance corresponding to the input pattern exists, a function corresponding to the input pattern is displayed in steps S1414 and S1416. When a result of the comparison indicates that the haptic pattern corresponding to the input pattern of the portable terminal is stored, at least one function that is applied to the haptic pattern stored in advance is displayed or executed. A haptic pattern is designated for each group or for each person in contacts stored in the portable terminal. The haptic pattern performs a function such as locking or unlocking the portable terminal, and executes an object. It is apparent that the present invention is applicable to all functions provided in a portable terminal in addition to the described functions.

It is appreciated that the embodiments of the present invention can be implemented in software, hardware, or a combination thereof. Any such software is stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be seen that a memory which is included in the mobile terminal corresponds to an example of the storage medium suitable for storing a program or programs including instructions by which the embodiments of the present invention are realized. Therefore, embodiments of the present invention provide a program including codes for implementing a system or method claimed in any claim of the accompanying claims and a non-transitory machine-readable device for storing such a program.

Such a program as described above can be electronically transferred through an arbitrary medium such as a communication signal transferred through cable or wireless connection, and the present invention properly includes the things equivalent to that. The above-described mobile terminal can receive the program from a program provision device which is connected thereto in a wired or wireless manner, and store the program. The program providing apparatus includes a memory for storing a program containing instructions for allowing the camera apparatus to perform a preset content protecting method and information required for the content protecting method, a communication unit for performing wired or wireless communication with the camera apparatus, and a controller for transmitting the corresponding program to the camera apparatus according to a request of the camera apparatus or automatically.

Although specific embodiments have been described in the detailed descriptions of the present invention, it is apparent that various modifications could be performed without departing from the scope of the present invention. Therefore, the scope of the present invention should not be defined as being limited to the embodiments, but should be defined by the appended claims and equivalents thereof.

What is claimed is:

1. A method of generating a haptic pattern in a portable terminal, the method comprising:
displaying a menu on a touch screen;
receiving an input for generating the haptic pattern through the displayed menu;
detecting, using a sensor module, a haptic input provided through the portable terminal; and
generating the haptic pattern based on the provided haptic input.

2. The method of claim 1, wherein the provided haptic input includes at least one of tapping on the portable terminal and shaking the portable terminal.

3. The method of claim 1, further comprising:
outputting a haptic feedback corresponding to the generated haptic pattern through a vibration motor of the portable terminal.

4. The method of claim 1, further comprising:
displaying the generated haptic pattern on the touch screen,
wherein the displayed haptic pattern is editable.

5. The method of claim 1, wherein the input received for generating the haptic pattern is performed by a finger or an input unit that is capable of communicating with the portable terminal.

6. The method of claim 5, further comprising:
transmitting a control signal corresponding to the generated haptic pattern to the input unit when the input for generating the haptic pattern is received.

7. The method of claim 1, wherein the menu includes a shaking setting associated with shaking the portable terminal, a tapping setting associated with tapping on the portable terminal, a threshold value setting for sensing the input pattern, and a musical instrument setting associated with a musical instrument to be applied to the haptic pattern.

8. The method of claim 1, further comprising:
applying the generated haptic pattern to at least one function from among a plurality of functions provided in the portable terminal.

9. The method of claim 1, wherein, when the provided haptic input corresponds to tapping on the portable terminal at least one time, the method further comprises:
measuring an intensity of the input tapping;
comparing the measured intensity to a threshold value; and
generating a haptic pattern using an intensity of tapping that exceeds the threshold value.

10. The method of claim 9, wherein the generated haptic pattern using the intensity is obtained by changing the intensity of the tapping that exceeds the threshold value into a voltage signal, and changing the voltage signal into a vibration signal.

11. The method of claim 1, wherein, when the provided haptic input corresponds to shaking the portable terminal at least one time, the method comprises:
measuring a speed of the input shaking;
comparing the measured speed to a threshold value; and
generating a haptic pattern using a speed of shaking that exceeds the threshold value.

12. The method of claim 11, wherein the generated haptic pattern using the speed of shaking is generated by changing the speed of the shaking that exceeds the threshold value into a voltage signal and changing the voltage signal into a vibration signal.

13. The method of claim 1, further comprising:
comparing the provided haptic input to a haptic pattern stored in advance; and
displaying a comparison result.

14. A portable terminal that generates a haptic pattern, the portable terminal comprising:
a touch screen configured to display a menu for generating a haptic pattern;
a sensor module; and
a controller configured to control generation of a haptic pattern based on an input for generating a haptic pattern, which is input through the displayed menu, and at least one haptic input from among tapping on the portable terminal and shaking the portable terminal, which is input through the portable terminal and is detected by the sensor module.

15. The portable terminal of claim 14, wherein the controller is configured to generate a haptic pattern based on at least one of a shaking setting associated with shaking the portable terminal, a tapping setting associated with tapping on the portable terminal, a threshold value setting that senses the input pattern, and a musical instrument setting associated with a musical instrument to be applied to the haptic pattern, which are input through the displayed menu, and at least one haptic input from among tapping on the portable terminal and shaking the portable terminal.

16. The portable terminal of claim 15, wherein the controller is configured to change an intensity of the tapping on the portable terminal or a speed of the shaking the portable terminal, which exceeds a threshold value, into a voltage signal, and to apply the voltage signal as an intensity of a sound of the set musical instrument and a vibration signal.

17. The portable terminal of claim 14, wherein the controller is configured to apply the generated haptic pattern to at least one function provided in the portable terminal.

18. The portable terminal of claim 14, wherein the controller is configured to display the generated haptic pattern on a touch screen, and the displayed haptic pattern is editable by a touch of an input unit.
